(19) United States
(12) Patent Application Publication
(10) Pub. No.: US 2004/0047647 A1
(43) Pub. Date: Mar. 11, 2004

(54) Electrophotographic printing device of modular construction

(76) Inventors: Bernd Schultheis, Schwabenheim (DE); Brigit Lattermann, Ried-Stadt (DE); Dieter Jung, Daaden (DE)

Correspondence Address: Pauley Petersen Kinne & Erickson, Suite 365, 2800 W Higgins Road, Hoffman Estates, IL, 60195, US

(21) Appl. No.: 10/399,619

(22) PCT Filed: Oct. 6, 2001
(86) PCT No.: PCT/EP01/11539

(30) Foreign Application Priority Data
Oct. 20, 2000 (DE) 100 52 371.4

(51) Int. Cl. G03G 15/00

(52) U.S. Cl. 399/107

(57) ABSTRACT

An electrophotographic printing device of modular construction with a support device, including a transport device, upon which a substrate may be transported between a start position and a target position and one or several electrophotographic units arranged on the support device, between the start and target position, having a developer unit, a photoconductor and an illumination unit for the photoconductor. The support device includes two or more housing positions arranged one behind the other in the transport direction of the transport device, provided with unitary mechanical interfaces. The electrophotographic units include unitary fixing pieces which are complementary in form to the interfaces. Such a printing device may be flexibly laid out due to the technical assembly thereof and may be individually set-up easily for specific printing jobs.

The invention relates to a modularly constructed electrophotographic printing device. A printing device is known from EP 0 896 256 A2, by means of which copy paper can be coated in a color print process. To this end, the printing device has four photo-conductor drums arranged one behind the other. The copy paper is passed along the photo-conductor drums by means of a conveyor belt. In the course of this it is possible to apply toner of a specific color to the copy paper by means of each photo-conductor drum.

Such printing devices are not suitable for industrial applications if, for example, plate-shaped workpieces are to be provided with a decorative print. For this application it is necessary to adapt the printing device specifically to the printing requirements. If, for example, it is intended to provide a two-color imprint or to apply a special toner, the printing device is not optimally laid out.

It is the object of the invention to create an electrophotographic printing device which can be laid out flexibly in respect to its technical complement and can be individually equipped for the specific print job with little outlay.

To attain this object, a modularly constructed electrophotographic printing device with a support device, which has a transporting device, on which a substrate can be transported between a start and a finish position, wherein one or more electrophotographic units are arranged on the support device between the start and finish positions, which have a developer unit, a photo conductor and an exposure unit assigned to the photo conductor, wherein the support device has selectively two or more receiving positions located one behind the other in the transporting direction of the transporting device, which are equipped with uniform mechanical interfaces, wherein the electrophotographic units have fastening elements, which are adapted to the interfaces, is proposed in the claims.

The electrophotographic units constitute independently functioning components, which can be positioned on the support device as selected by the user. Depending on the printing order to be filled, one or several electrophotographic units can be employed. Because of this it is then possible to sequentially employ different toners with different technical properties or different colors for decorating and/or modifying surface properties of plate-shaped materials. Since the support device forms uniform mechanical interfaces, the electrophotographic units can be simply mounted and assigned.

The assembly effort can be further reduced if it is additionally provided that the receiving positions are equipped with uniform electrical interfaces, preferably with a bus system.

It can be provided in accordance with a possible variation of the invention that the support device is put together from at least two partial frames placed one behind the other, and that the partial frames are structurally identical and each has at least one receiving position for an electrophotographic unit. In this way it is possible to construct the support device so that it is adapted to individual requirements in the desired way. In connection with this, the number of electrophotographic units to be employed will mainly determine the number of partial frames.

In this case it is also possible to additionally provide that the transporting device is conducted as a uniform component over all partial frames, or that each partial frame has its own partial transporting device, and that the individual partial transporting devices are coupled with each other mechanically and/or by means of an electrical drive control for forming a uniform transporting device. The connection of the partial transporting devices assures synchronous feeding, so that the substrate can be transported at a steady speed.

To assure an orderly supply of substrates, it can be provided that a centering module is installed on the support device in the area of the start position. Thus, the centering module also represents a uniform component which can be connected with the printing device in the manner of a kit.

In this connection it can be furthermore provided that a pre-centering module is connected upstream of the centering module in the transporting direction, and that the precentering module is installed on the support device or the centering module. Together with the centering module, the pre-centering module assures an exact alignment of the substrate and its orderly feeding.

In accordance with a preferred embodiment of the invention it is provided that a fixation module is arranged on the support device or on the electrophotographic unit, which is used for pre-fixation or fixation of the toner applied to the substrate. After the toner has been applied by one or more of the electrophotographic units, the toner can be bonded to the surface of the substrate by the fixation module by means of a suitable energy application. Pre-fixation of the toner following the completed toner application is in particular practical in case ceramic colors, for example, are to be printed. Usually these ceramic colors are applied to substrates made of glass or of a glass-ceramic material. After leaving the printing device, the substrate with the pre-fixated toner is taken to a unit for final fixation, in which the toner is fixated at a high temperature, in connection with ceramic toners in particular is burned in, or in case of pressure-setting plastic material is cured.

1. A modularly constructed electrophotographic printing device with a support device (15), which has a transporting device (16) on which a substrate can be transported between a start and a finish position, wherein one or more electrophotographic units (12a to d) are arranged on the support device (15) between the start and finish positions, which have a developer unit, a photo conductor and an exposure unit assigned to the photo conductor, wherein the support device (15) has selectively two or more receiving positions located one behind the other in the transporting direction of the transporting device (16), which are equipped with uniform mechanical interfaces, wherein the electrophotographic units (12a to d) have fastening elements, which are adapted to the interfaces.

2. The printing device in accordance with claim 1,
characterized in that
the receiving positions are equipped with uniform electrical interfaces, preferably with a bus system.

3. The printing device in accordance with claim 1 or 2,
characterized in that
the support device (15) is put together from at least two partial frames placed one behind the other, and
the partial frames are structurally identical and each has at least one receiving position for an electrophotographic unit.

4. The printing device in accordance with claim 3,
characterized in that
the transporting device (16) is conducted as a uniform component over all partial frames (15), or
each partial frame has its own partial transporting device, and
the individual partial transporting devices are coupled with each other mechanically and/or by means of an electrical drive control for forming a uniform transporting device (16).

5. The printing device in accordance with one of claims 1 to 4,
characterized in that
a centering module (11) is installed on the support device (15) in the area of the start position.

6. The printing device in accordance with claim 3,
characterized in that
a pre-centering module (10) is connected upstream of the centering module (11) in the transporting direction, and
the pre-centering module (10) is installed on the support device (15) or the centering module (11).

7. The printing device in accordance with one of claims 1 to 6,
characterized in that
a fixation module (13) is arranged on the support device (15) or on the electrophotographic unit (12a to d), which is used for pre-fixation or fixation, for example for burning in or curing of the toner applied to the substrate.

8. The printing device in accordance with claim 7,
characterized in that
the fixation module (13) has fastening elements by means of which it can be connected to the interfaces of the support device (15).

9. The printing device in accordance with one of claims 5 or 6,
characterized in that
a fixation module (13) is arranged following each electrophotographic unit (12a to d).

10. The printing device in accordance with one of claims 1 to 9,
characterized in that
a delivery module (14), for example a stacking device, is attached to the support device (15) in the area of the finish position.

11. The printing device in accordance with one of claims 1 to 10,
characterized in that
a delivery module (14) for linkage with a further processing device is arranged in the area of the finish position.

12. The printing device in accordance with one of claims 1 to 11,
characterized in that
every electrophotographic unit has a transfer system (12.2) for transferring the toner to the substrate, and
a primary charging means (12.1) is connected upstream in the transport direction to the transfer system, and a secondary charging means (12.3) downstream in the transport direction.

13. The printing device in accordance with one of claims 1 to 12,
characterized in that
four electrophotographic units (12a to d) are installed on the support device (15) for forming a full color printing system, wherein colored toners, namely cyan-, magenta-, yellow- or black-colored toner is stored in the individual electrophotographic units.

14. Use of the printing device in accordance with one of claims 1 to 12 for imprinting flat rigid substrates.
